(19) United States
(12) Patent Application Publication
(10) Pub. No.: US 2011/0188915 A1
(43) Pub. Date: Aug. 4, 2011

(54) Press Key Structure of Keyboard

(76) Inventor: Tao-Shen Chen, Chung Li City (TW)

(21) Appl. No.: 12/696,739

(22) Filed: Jan. 29, 2010

(51) Int. Cl. B41J 5/00

(52) U.S. Cl. 400/495

(57) ABSTRACT

A press key structure includes a keycap, a base, and two crossed pivotal support stands. Both ends of the two support stands are abutted against the keycap and the base, and the keycap and the base includes pivot lugs for pivotally coupling axle portions at both ends of the support stands, and an inverted hook disposed at each pivot lug, and the axle portions at both ends of the support stands are prevented from sliding freely out the pivot lugs without the interference by the inverted hook. During an assembling process, the two crossed pivotal support stands are latched with the pivot lugs on a side of the base first, and then latched with the pivot lugs on a side of the keycap to achieve the fixing effect, and finally the top of the keycap is pressed gently to complete the assembling process.

### BACKGROUND OF THE INVENTION

1. Field of the Invention

The present invention relates to a keyboard structure, and more particularly to an improved, stable and reliable press key structure that can be assembled easily to save labor cost and manufacturing time.

2. Description of the Related Art

Computer is used extensively in various information processing areas such as information traffic, commercial activities, customer correspondence, word processing, computer graphics, handwriting input and complicated routine jobs, etc, and thus computer is indispensable to our daily life. Keyboard is one of the necessary peripherals of the computer, and press keys are provided for the operation of the keyboard, such that program instructions or data can be inputted into a computer host quickly and conveniently, and thus, keyboard plays an important role as an input device for computer operations.

With reference to FIG. 1 for a cross-sectional view of a conventional press key structure of a personal computer, the press key structure comprises a keycap 11, a base 12 and two crossed pivotal support stands 13, 14 connected between the keycap 11 and the base 12, wherein both ends of the two support stands 13, 14 are abutted against the keycap 11 and the base 12 respectively, and the keycap 11 and the base 12 include pivot lugs 111, 121 for pivotally coupling axle portions at both ends of the support stands 13, 14, such that the keycap 11 and the base 12 are coupled with each other, and a link mechanism is provided for moving the keycap 11 up and down stably and reciprocally.

In a process of assembling the keycap 11, the base 12 and the two support stands 13, 14, the two support stands 13, 14 include an axle hole 131 and an axle 141 formed at corresponding crossed pivotal positions, and a breach 132 is formed at a main body underneath the axle hole 131 and provided for sheathing the axle 141 into the axle hole 131. However, the axle hole 131 does not come with a design of restricting the axle 141 from entering into or exiting from the axle hole 131, so that there is a risk for the keycap 11 to fall out.

### SUMMARY OF THE INVENTION

In view of the shortcomings of the prior art, the inventor of the present invention based on years of experience in the related industry to conduct extensive researches and experiments, and finally developed a press key structure in accordance with the present invention to provide a better texture and a more secured and reliable press key structure, and simplify the assembling process of the press key structure of a keyboard, so as to lower the manufacturing cost and produce a better waterproof keyboard structure.

Therefore, it is a primary objective of the present invention to overcome the aforementioned shortcoming and deficiency of the prior art by providing a press key structure in accordance with the present invention.

To achieve the foregoing objective, the present invention provides a press key structure of a keyboard, and the press key structure comprises a keycap, a base and two crossed pivotal support stands coupled between the keycap and the base, wherein both ends of the two support stands are abutted against the keycap and the base respectively, and the keycap and the base include pivot lugs for pivotally coupling both ends of the support stands with the axle portion, and an inverted hook is installed at the pivot lug, such that both ends of the support stands are restricted from sliding out freely from the pivot lugs of the axle portion under the interference effect of the inverted hook.

However, the press key structure of the keyboard of the present invention has a support board (made of a metal or rubber material) and a circuitry membrane installed sequentially from top to bottom, wherein the circuitry membrane has an electric contact point disposed at a position corresponding to the press key, and the support board is installed underneath the circuitry membrane and provided for supporting the circuitry membrane, and a base (or a positioning board) is installed above the circuitry membrane and has a through hole formed at a position corresponding to the electric contact point, and the base (or positioning board) includes a positioning portion of the pivot lug of the base disposed at a position for installing the keycap of the press key and provided for positioning the support stands.

If the axle protons at both ends of the support stands are sheathed into the pivot lugs, the axle portions have to pass through the inverted hooks first, and thus an obvious texture of touch is produced under the interference effect of the axle portions at both ends of the support stands and the inverted hooks, such that users or assemblers can determine that the axles have passed through the inverted hook into the axle hole, so as to enhance the assembling availability of the press keys. The two support stands include an axle hole and an axle formed at corresponding crossed pivotal positions, and a breach is formed at a main body underneath the axle hole and provided for sheathing the axle, and an inverted hook is installed at an opening position of the breach and extended into an insert path of the axle, such that the axle is restricted from retracting from the axle hole under the interference effect of the inverted hooks, and the overall press key structure will become more secured and reliable.

Further, if the axle is sheathed into the axle hole, the axle has to pass through the inverted hook first, and an obvious texture of touch will be produced under the interference effect of the axle and the inverted hook such that users or assemblers can determine that the axles have passed through the inverted hook into the axle hole, so as to save manpower and time for the assembling and enhance the assembling availability of the press keys.

### BRIEF DESCRIPTION OF THE DRAWINGS

FIG. 1 is a cross-sectional view of a conventional press key structure;

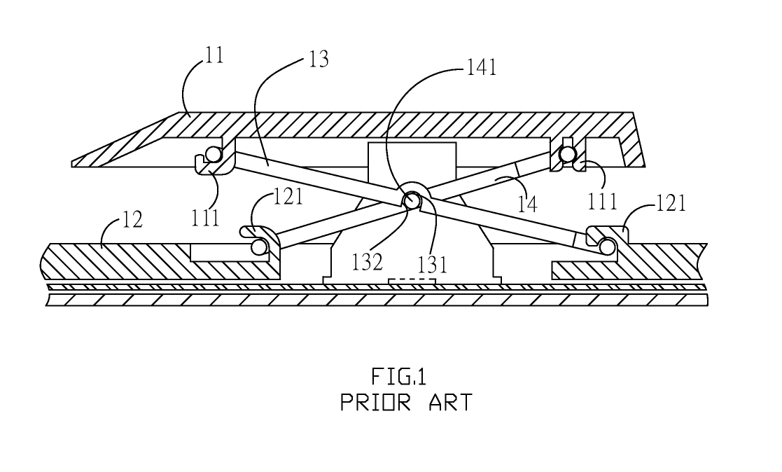

FIG. 2 is a perspective exploded view of a press key structure in accordance with the present invention;

FIG. 3 is another perspective exploded view of a press key structure in accordance with the present invention;

FIG. 4 is a schematic view of an assembly of two support stands in accordance with the present invention;

FIG. 5 is a cross-sectional view of a press key structure in accordance with a first preferred embodiment of the present invention;

FIG. 6 is another cross-sectional view of a press key structure in accordance with a first preferred embodiment of the present invention;

FIG. 7 is an enlarged view of a breach structure in accordance with a first preferred embodiment of the present invention;

FIG. 8 is a cross-sectional view of a press key structure in accordance with a second preferred embodiment of the present invention;

FIG. 9 is another cross-sectional view of a press key structure in accordance with a second preferred embodiment of the present invention; and

FIG. 10 is an enlarged view of a breach structure in accordance with a second preferred embodiment of the present invention.

### DETAILED DESCRIPTION OF THE PREFERRED EMBODIMENTS

The technical characteristics of the present invention will become apparent with the detailed description of the preferred embodiments and the illustration of the related drawings.

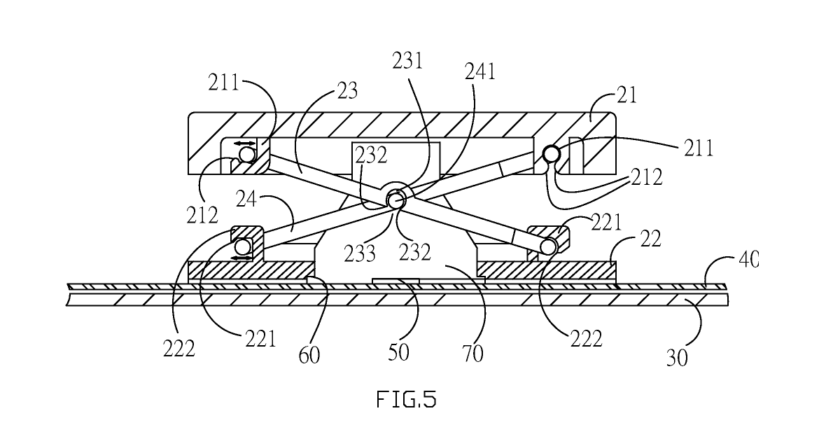

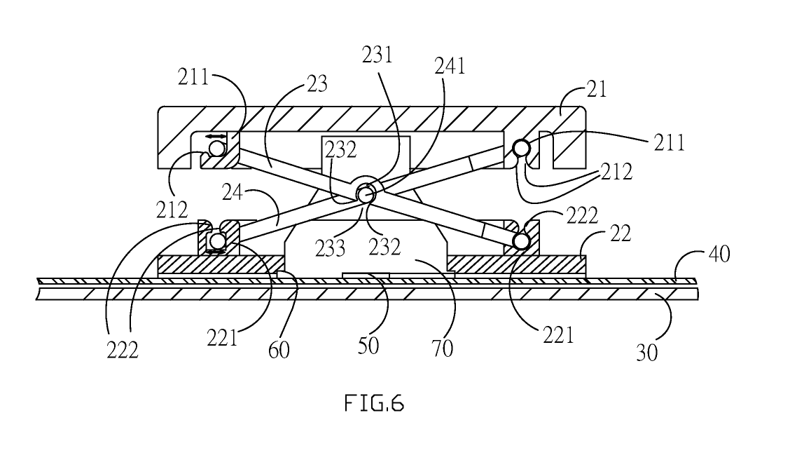

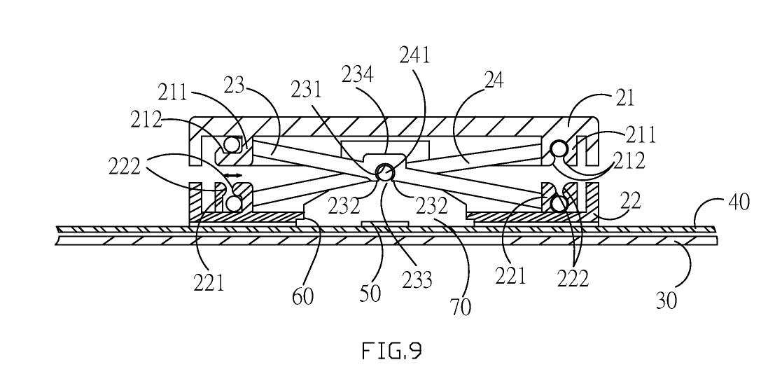

With reference to FIGS. 5, 6, 8 and 9 for a press key structure of a keyboard in accordance with the present invention, the press key structure comprises a support board 30, a circuitry membrane 40 and an elastic coupling body 70, wherein the circuitry membrane 40 includes an electric contact point 50 formed at a position corresponding to a press key; a support board 30 installed underneath the circuitry membrane 40, for supporting the circuitry membrane 40; a base 22 (or a positioning board) disposed above the circuitry membrane 40 and having a through hole 60 formed at a position corresponding to the electric contact point 50, and a pivot lug 221 disposed at a position of the base 22 (or positioning board) for installing a keycap 21 of the press key and provided for positioning the support stands 23, 24.

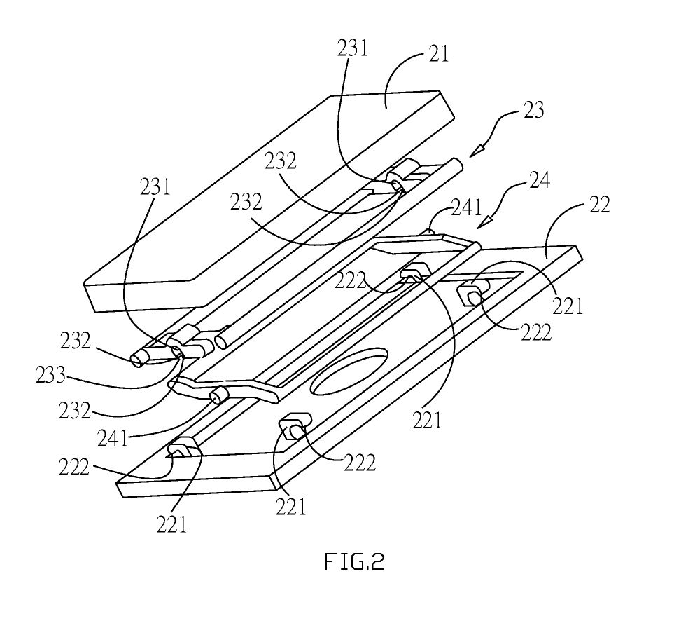

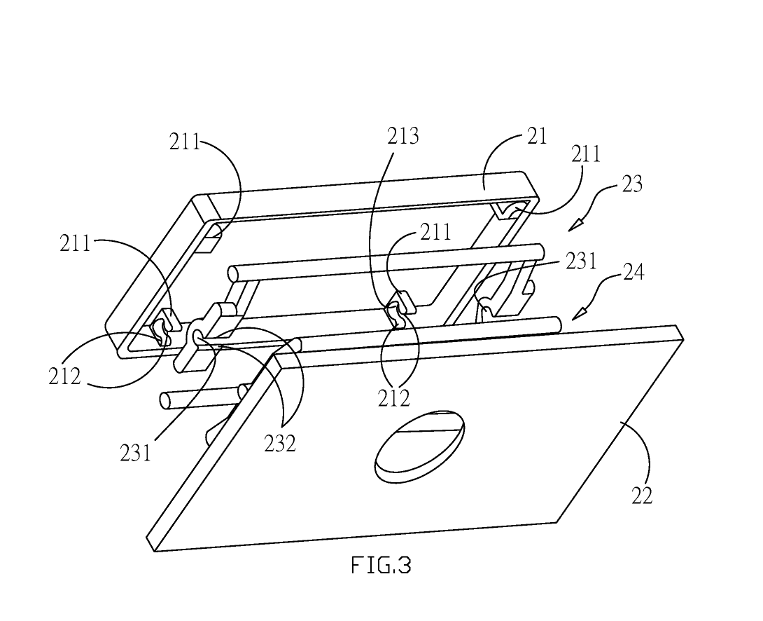

The press key structure of a keyboard in accordance with the present invention as shown in FIGS. 2, 3, 5 and 6 comprises: a base 22, a keycap 21, and two crossed pivotal support stands 23, 24 coupled between the keycap 21 and the base 22.

A pair of pivot lugs 221 are disposed two corresponding sides at the top of the base 22 respectively for pivotally coupling the axle portions at both ends of the two support stands 23, 24, and an inverted hook 222 is formed at a breach of the two pairs of pivot lugs 221 and extended into an insert path of the axle portion. The keycap 21 is installed above the base 22, and a pair of pivot lugs 211 are installed at the bottom of the two corresponding sides of the keycap 21 for pivotally coupling axle portions at both ends of the two support stands 23, 24, and an inverted hook 212 is formed at a breach of the two pairs of pivot lugs 211 and extended into an insert path of the axle portion.

The axle portions at both ends of the two support stands 23, 24 are respectively and pivotally coupled to the pivot lugs 221, 211 of the base 22 and the keycap 21 and abutted against the base 22 and a main body of the keycap 21 to couple the keycap 21 with the base 22, and a link mechanism for moving keycap 21 stably and reciprocally up and down.

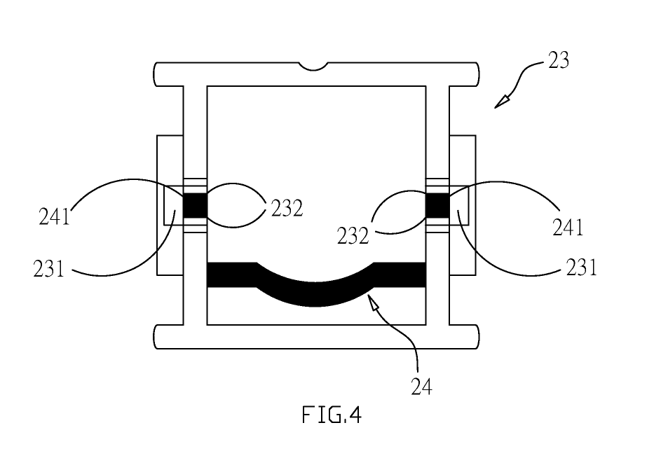

In FIG. 4, the two support stands 23, 24 include an axle hole 231 and an axle 241 disposed at corresponding crossed pivotal positions, and a breach 233 is formed at a main body underneath the axle hole 231 for sheathing the axle into the axle hole 231, and an inverted hook 232 is installed at an opening of the breach 233 and extended into an insert path of the axle 241.

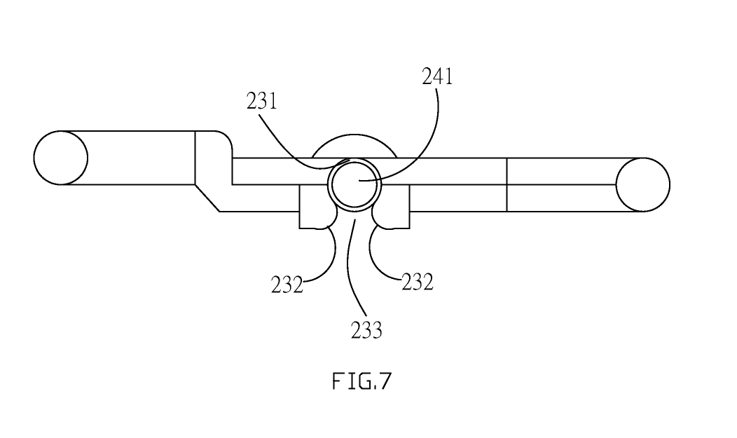

In FIG. 7, the overall press key structure can restrict the axle 241 from retracting out of the axle hole 231 to prevent the two crossed pivotal support stands 23, 24 from being loosened with the interference effect of the inverted hook 232 at the breach 233 and the axle 241.

Further, the interference effect of the inverted hook 212 of the pivot lug 211 of the keycap 21 and the axle portion at rear ends of the two support stands 23, 24 can prevent the keycap 21 from being loosened or falling out, such that the overall press key structure becomes more secured and reliable.

If the axle 241 is sheathed into the axle hole 231, and the axle portions at the rear ends of the support stands 23, 24 are sheathed into the pivot lugs 211, it is necessary to pass them through the inverted hooks 232, 222 first, and an obvious texture of touch is produced under the interference effect of the inverted hooks 232, 222, such that users or assemblers can determine that the axles have passed through the inverted hook into the axle hole, so as to save manpower and time for the assembling and enhance the assembling availability of the press keys.

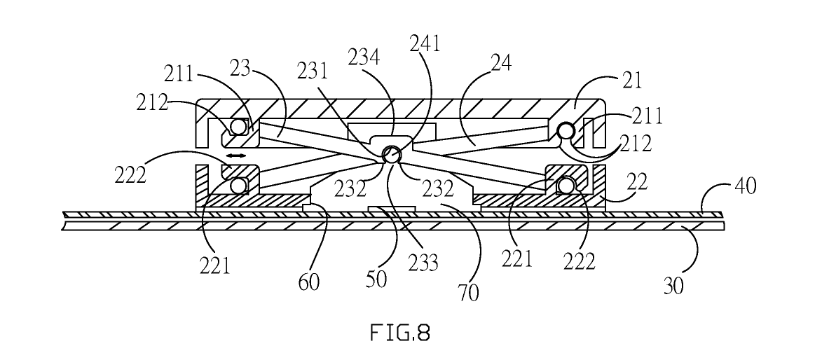

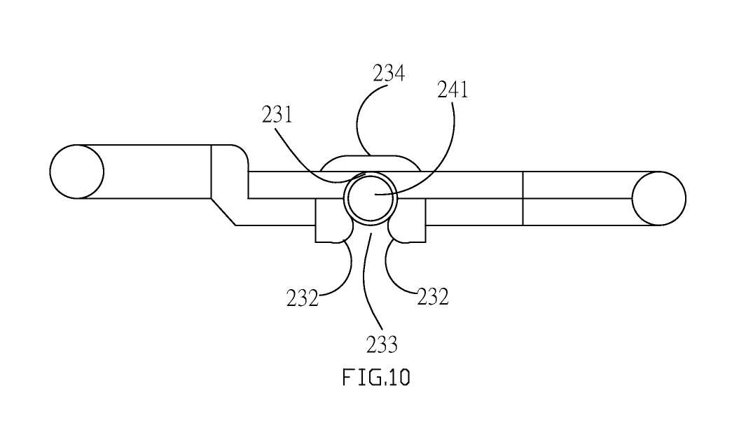

It is noteworthy to point out that the keyboard press key structure of the present invention as shown in FIGS. 8 to 10 has a flat tangent plane 234 disposed at a main body above the axle hole 231 and provided for reducing the height of the main body above the axle hole 231, so as to reduce the height of the keycap 22, such that the overall press key structure can comply with the design requirement of a thin keyboard for notebook computers.

The present invention improves over the prior art and complies with patent application requirements, and thus is duly filed for the patent application. While the invention has been described by device of specific embodiments, numerous modifications and variations could be made thereto by those generally skilled in the art without departing from the scope and spirit of the invention set forth in the claims.

What is claimed is:

1. A press key structure of a keyboard, comprising:
a base, having a pair of pivot lugs disposed on two corresponding sides at the top of the base respectively;
a keycap, disposed above the base, and having a pair of pivot lugs disposed on two corresponding sides at the bottom of the keycap;
two crossed pivotal support stands, having an axle portion disposed separately at both ends of the two support stands and pivotally coupled with the base and the pivot lugs of the keycap, an inverted hook extended into a breach of the two pairs of pivot lugs of the keycap, a breach of the two pairs of pivot lugs of the base, and an insert path of an axle portion of the support stands, and the two support stands having an axle hole and an axle disposed at corresponding crossed pivotal positions, a breach formed at a main body underneath the corresponding axle hole for sheathing the axle into the axle hole, and an inverted hook disposed at an opening position of the breach and extended into the insert path of the axle.

2. The press key structure of a keyboard as recited in claim 1, wherein the axle hole includes a flat tangent place disposed at top of the main body.
